(19) United States
(12) Patent Application Publication
(10) Pub. No.: US 2025/0370812 A1
(43) Pub. Date: Dec. 4, 2025

(54) Managing Operator Custom Resource Reconciliation

(71) Applicant: International Business Machines Corporation, Armonk, NY (US)

(72) Inventors: Zhi Li Guan, Beijing (CN); Shi Su, Beijing (CN); Fang Tai L Li, Beijing (CN); Yun Diao, Beijing (CN); Guo Liang Huang, Beijing (CN); Hai Wei Fang, Tianjin (CN)

(21) Appl. No.: 18/677,026

(22) Filed: May 29, 2024

(51) Int. Cl. G06F 9/50

(52) U.S. Cl. CPC G06F 9/5033

(57) ABSTRACT

Managing reconciliation of custom resources by operators is provided. An operator is run to perform a reconciliation process to reconcile a current state of a custom resource with a desired state for the custom resource in response to one or more changes being detected in at least one of the custom resource and a set of objects corresponding to the custom resource. A new reconcile result is received from the operator after performing the reconciliation process. It is determined whether the new reconcile result is success. In response to determining that the new reconcile result is success, a snapshot of the custom resource along with the set of objects corresponding to the custom resource is captured. The reconciliation process of the operator is suspended until one or more other changes are detected in at least one of the custom resource and the set of objects corresponding to the custom resource.

### BACKGROUND

The disclosure relates generally to orchestration environments and more specifically to reconciling custom resources in an orchestration environment.

An orchestration environment or platform, such as, for example, Kubernetes® (a registered trademark of the Linux Foundation of San Francisco, California, USA), provides an architecture for automating deployment, scaling, and operations of application workloads across clusters of host nodes. Typically, an orchestration environment includes, for example, a control node, which is a main controlling unit of a cluster of host nodes (also known as worker nodes, compute nodes, minions, and the like), managing the cluster's workload, and directing communication across the cluster. A host node is a machine, either physical or virtual, where an application workload is deployed. The host node hosts components of the application workload.

The control plane of the cluster of host nodes, which the control node forms, consists of various components, such as, for example, a data store, application programming interface (API) server, scheduler, and the like. The data store contains configuration data of the cluster, representing the overall and desired state of the cluster at any given time. The API server provides internal and external interfaces for the control node. The API server processes and validates resource availability requests and updates state of objects in the data store, thereby allowing users to configure application workloads across host nodes in the cluster. The scheduler selects which host node a workload runs on, based on resource availability of respective host nodes. For example, the scheduler tracks resource utilization on each host node to ensure that workload is not scheduled in excess of available resources.

A resource in an orchestration environment stores a set of application programming interface (API) objects of a certain kind (e.g., a built-in container resource contains a set of container objects). A custom resource enables a user to create API objects. In other words, a custom resource allows the user to extend orchestration environment capabilities beyond the default installation by adding any kind of API object useful to an application. Thus, a custom resource represents a customization of a particular orchestration environment installation. A custom resource definition defines a custom resource. Custom resources can appear and disappear in a running cluster of host nodes through dynamic registration, and cluster administrators can update custom resources independently of the cluster itself. Once a custom resource is installed, users can create and access its objects just as the users do for built-in resources, such as containers.

### SUMMARY

According to one illustrative embodiment, a computer-implemented method for managing reconciliation of custom resources by operators is provided. A computer runs an operator to perform a reconciliation process to reconcile a new current state of a custom resource with a desired state for the custom resource in response to one or more changes being detected in at least one of the custom resource and a set of objects corresponding to the custom resource. The computer receives a new reconcile result from the operator after performing the reconciliation process to reconcile the new current state of the custom resource with the desired state for the custom resource in response to the one or more changes being detected in at least one of the custom resource and the set of objects corresponding to the custom resource. The computer determines whether the new reconcile result is success. In response to the computer determining that the new reconcile result is success, the computer captures a new snapshot of the custom resource along with the set of objects corresponding to the custom resource after successful reconciliation of the new current state of the custom resource with the desired state for the custom resource. The computer suspends the reconciliation process of the operator again until one or more other changes are detected in at least one of the custom resource and the set of objects corresponding to the custom resource. According to other illustrative embodiments, a computer system and computer program product for managing reconciliation of custom resources by operators are provided.

### BRIEF DESCRIPTION OF THE DRAWINGS

FIG. 1 is a pictorial representation of a computing environment in which illustrative embodiments may be implemented;

FIG. 2 is a diagram illustrating an example of an orchestration environment in accordance with an illustrative embodiment;

FIG. 3 is a diagram illustrating an example of a custom resource reconciliation process in accordance with an illustrative embodiment;

FIG. 4 is a diagram illustrating an example of a custom resource definition in accordance with an illustrative embodiment;

FIG. 5 is a diagram illustrating an example of a custom resource in accordance with an illustrative embodiment;

FIG. 6 is a diagram illustrating an example of an extended custom resource definition in accordance with an illustrative embodiment;

FIG. 7 is a diagram illustrating an example of a reconcile manager process in accordance with an illustrative embodiment; and

FIGS. 8A-8C are a flowchart illustrating a process for managing reconciliation of custom resources by operators in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

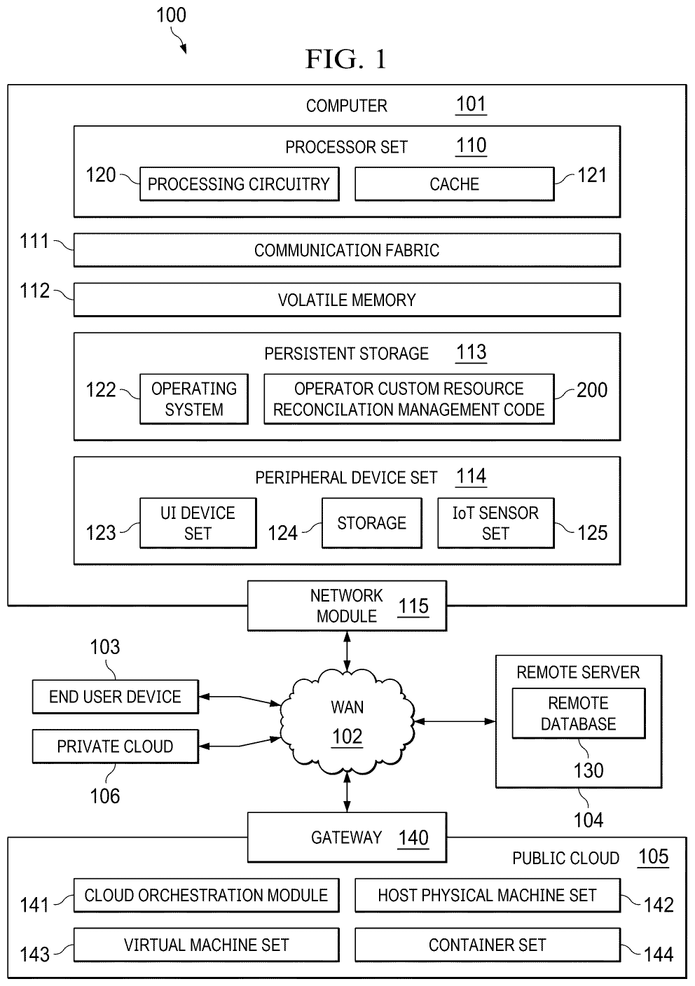

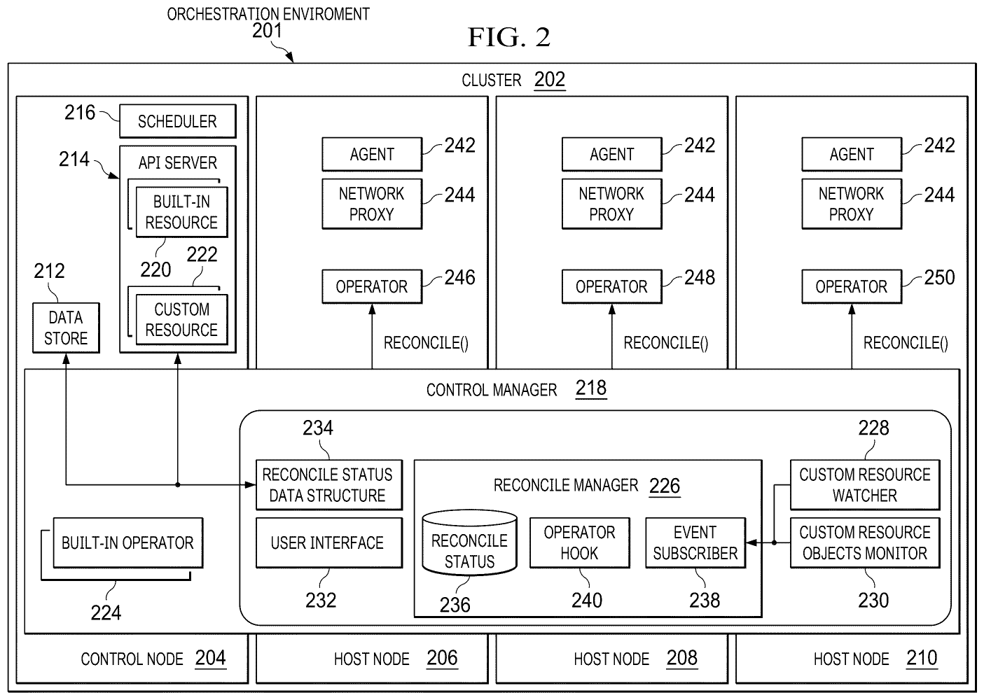

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an orchestration environment (e.g., Kubernetes or the like) for the execution of at least some of the computer code involved in performing the inventive methods of illustrative embodiments, such as operator custom resource reconciliation management code 200. For example, operator custom resource reconciliation management code 200 controls the suspension and reactivation of the custom resource reconciliation processes of operators running in host nodes to decrease host node resource utilization, thereby increasing host node performance. The operators try to reconcile the current state of corresponding custom resources to the desired state for those corresponding custom resources. Whether the reconcile result returned by an operator for a custom resource is success or failure, operator custom resource reconciliation management code 200 suspends the reconciliation process of that particular operator until a predefined condition is met. The predefined condition may be, for example, a change in the custom resource itself, a change in one or more objects associated with that custom resource, a specified time interval, input from a user interface, or the like.

In addition to operator custom resource reconciliation management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and operator custom resource reconciliation management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in operator custom resource reconciliation management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a cluster administrator who utilizes the operator custom resource reconciliation management services provided by computer 101), and may take any of the forms discussed above in connection with computer 101. EUD 103 typically receives helpful and useful data from the operations of computer 101. For example, in a hypothetical case where computer 101 is designed to provide an operator custom resource reconcile result to the end user, this reconcile result would typically be communicated from network module 115 of computer 101 through WAN 102 to EUD 103. In this way, EUD 103 can display, or otherwise present, the operator custom resource reconcile result to the end user. In some embodiments, EUD 103 may be a client device, such as a thin client, heavy client, mainframe computer, desktop computer, laptop computer, tablet computer, smart phone, smart glasses, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a custom resource reconciliation recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Operators are software extensions to an orchestration environment (e.g., Kubernetes or the like) that utilize custom resources to manage applications and their components. These custom resources are the primary interface for a user. The operator pattern enables a user to extend a cluster's behavior without modifying the code by linking operators to custom resources. Each operator includes a set of controllers that manage a custom resource owned by that particular operator.

An operator utilizes a reconciliation process (e.g., a control loop) that tries to move the current state of a corresponding custom resource to a desired state for that custom resource. The operator runs each time an event occurs on its corresponding custom resource and will return a reconcile result depending on whether the current state and the desired state match or not. Based on the reconcile result (e.g., success or failure), the operator may re-queue the reconcile request, which may trigger the reconciliation process again.

One issue with the reconcile result of an operator is that the reconcile result only supports success or failure. If the operator returns a reconcile result of failure, then any update to the custom resource will not be recognized. The operator only returns a reconcile result of success when the current state of the custom resource is the same as (i.e., matches) the desired state for the custom resource. When an error occurs and the reconcile result is failure, currently the operator will continue to try to reconcile the custom resource even though a user (e.g., cluster administrator) does nothing to fix the error. In this case, the reconcile result is foreseeable (i.e., reconciliation of the custom resource will fail). In other words, currently the custom resource reconciliation process of the operator will not stop even though there is no change (i.e., the user has not fixed the error).

Illustrative embodiments perform operator management to prevent unnecessary performance of the custom resource reconciliation process by operators, thus saving cluster (e.g., host node) resources. Illustrative embodiments suspend the reconciliation process of an operator and only resume the reconciliation process when a defined condition is met, or a custom resource change event occurs. Thus, illustrative embodiments using a plurality of different components, such as, for example, a reconcile manager, custom resource watcher, custom resource objects monitor, and user interface, support intelligent reconciliation of custom resources in a cluster by operators.

It should be noted that a user can run or suspend the custom resource reconciliation process on demand via the user interface. To provide the user interface or an application programming interface (API) to trigger the reconciliation process of an operator, illustrative embodiments can utilize, for example, a web console or an API endpoint that allows the user or an external system to initiate the reconciliation process. The user interface can include, for example, a button that the user can activate via an input, such as a mouse click, to trigger the reconciliation process. For the API endpoint, illustrative embodiments can define the API endpoint uniform resource locator (URL) and hypertext transfer protocol (HTTP) method (e.g., POST) that will trigger the reconciliation process.

Illustrative embodiments extend custom resource definitions of custom resources by adding a reconcile status field that indicates a current reconciliation state of corresponding operators. The reconcile status field indicates whether the reconciliation process of a corresponding operator should be in a running state or a suspended state. In addition, the reconcile status field stores a hash (e.g., an MD5 hash or the like) of the objects corresponding to the custom resource managed by that particular operator. The hash can represent a change in the objects involved in the customer resource.

Illustrative embodiments monitor events that may impact the reconciliation process of an operator. For example, illustrative embodiments utilize a custom resource watcher to monitor the API server to identify a custom resource change event and notify the corresponding operator regarding the custom resource change event to start the reconciliation process on that particular custom resource. In other words, the custom resource watcher is responsible for monitoring changes to the custom resource, which stores configuration and status information. The custom resource watcher monitors for and reacts to modifications to the custom resource by a user (e.g., cluster administrator). As a result, the custom resource watcher provides a mechanism for an operator to respond to changes in the configuration of or requested actions by the custom resource. It should be noted that the custom resource watcher filters events that are only related to the specification section of the custom resource that impact the reconciliation process of the corresponding operator.

Illustrative embodiments also utilize the custom resource-involved objects monitor to monitor the objects involved in that particular custom resource. The objects are, for example, YAML files, JSON files, or the like that describe the desired state of the custom resource within the cluster, such as configuration maps, secrets, deployments, services, and the like.

Illustrative embodiments utilize the reconcile manager to subscribe to the output of both the custom resource watcher and custom resource-involved objects monitor to determine whether any changes have been made to a particular custom resource or one or more of the objects involved with that particular custom resource. The reconcile manager suspends the custom resource reconciliation process of the operator when the reconciliation process completes successfully for the custom resource or when the reconciliation process fails due to an error during reconciliation. The reconcile manager only resumes the reconciliation process when a change to the custom resource occurs, when a change to the objects involved in the custom resource occurs, or on demand by a user via the user interface. The reconcile manager records the reconcile status (i.e., running or suspended) in a reconcile status data structure. Moreover, the reconcile manager captures a snapshot of the custom resource, along with its custom resource-involved objects, after the operator successfully reconciles the current state of the custom resource with the desired state for the custom resource. The reconcile manager then stores the snapshot in the data store.

Thus, illustrative embodiments enable the operator to run the custom resource reconciliation process only as needed, enabling the operator to respond to configuration changes or environmental shifts. Furthermore, illustrative embodiments prevent unnecessary and repetitive custom resource reconciliation, increasing cluster performance by decreasing cluster resource utilization.

Consequently, illustrative embodiments provide one or more technical solutions that overcome a technical problem with a current inability to suspend the custom resource reconciliation processes of operators running in host nodes. As a result, these one or more technical solutions provide a technical effect and practical application in the field of orchestration environments.

With reference now to FIG. 2, a diagram illustrating an example of an orchestration environment is depicted in accordance with an illustrative embodiment. Orchestration environment 201 may be implemented in a computing environment, such as computing environment 100 in FIG. 1. Orchestration environment 201 is a system of hardware and software components for managing the reconciliation of custom resources by corresponding operators.

In this example, orchestration environment 201 includes cluster 202. Cluster 202 represents a group of compute nodes or machines that work together to run one or more application workloads. In this example, cluster 202 includes control node 204, host node 206, host node 208, and host node 210. However, it should be noted that cluster 202 can include any number of control and host nodes.

Control node 204 provides the control plane for host node 206, host node 208, and host node 210. In this example, control node 204 includes a plurality of components, such as data store 212, API server 214, scheduler 216, and controller manager 218. However, it should be noted that control node 204 can also include other components not shown.

Data store 212 contains configuration data of cluster 202, representing the overall and desired state of host nodes in cluster 202 at any given time. API server 214 provides internal and external interfaces for control node 204. In addition, API server 214 processes and validates resource availability requests and updates state of objects in data store 212, thereby allowing users to configure application workloads across host nodes in cluster 202. Scheduler 216 selects which host node an application workload runs on, based on resource availability of respective host nodes. Controller manager 218 manages the deployment of operators on host nodes in cluster 202.

In this example, API server 214 includes built-in resource 220 and custom resource 222. Built-in resource 220 represents a built-in, default, or standard resource of orchestration environment 201. Custom resource 222 represent a customization or extension of capabilities of orchestration environment 201. Moreover, each of built-in resource 220 and custom resource 222 can represent a plurality of different resources and a plurality of different custom resources, respectively. Similarly, controller manager 218 includes built-in operator 224. Built-in operator 224 represent a built-in, default, or standard operator of orchestration environment 201. Furthermore, built-in operator 224 can represent a plurality of different operators.

In this example, controller manager 218 also includes reconcile manager 226, custom resource watcher 228, custom resource objects monitor 230, user interface 232, and reconcile status data structure 234. Controller manager 218 utilizes reconcile manager 226 to suspend or run the reconciliation process of operators deployed and running in host node 206, host node 208, and host node 210. Reconcile manager 226 utilizes reconcile status data structure to store reconcile status 236, which corresponds to a particular operator. Reconcile status 236 of that particular operator can be either suspended or running. Reconcile manager 226 utilizes custom resource watcher 228 and custom resource objects monitor 230 to detect change events corresponding to custom resources in host node 206, host node 208, and host node 210, along with changes to objects involved in the custom resources.

Reconcile manager 226 utilizes event subscriber 238 to receive the output of custom resource watcher 228 and custom resource objects monitor 230 containing the detected changes to custom resources or one or more objects involved in the custom resources. Reconcile manager 226 utilizes operator hook 240 to make operators running on host node 206, host node 208, and host node 210 aware of custom resource or custom resource object change events and to run the custom resource reconciliation process.

In this example, each of host node 206, host node 208, and host node 210 include agent 242 and network proxy 244. Agent 242 (e.g., a kubelet or the like) ensures that application workload is running on a respective host node. For example, if an application workload on a particular host node is not running, then agent 242 directs API server 214 to terminate and restart the application workload. Network proxy 244 (e.g., a kube-proxy or the like) maintains network rules for communicating with other nodes in cluster 202.

Further, host node 206 includes operator 246, host node 208 includes operator 248, and host node 210 includes operator 250. Each of operator 246, operator 248, and operator 250 reconciles a specific type of custom resource, such as custom resource 222, defined as a custom resource definition. Operator 246, operator 248, and operator 250 each generates a set of objects corresponding to its specific type of custom resource. The generated objects are stored in data store 212. Operator 246, operator 248, and operator 250 may be, for example, customized instances of built-in operator 224. A user deploys operator 246, operator 248, and operator 250 to cluster 202. Then, controller manager 218 runs controller processes. Each of operator 246, operator 248, and operator 250 starts to watch its corresponding specific type of custom resource. In response to reconcile manager 226 receiving an indication from at least one of custom resource watcher 228 or custom resource object monitor 230 that a change event corresponding to a specific type of custom resource has occurred, reconcile manager 226 directs the corresponding operator, such as operator 246, to run the reconciliation process to reconcile the current state of that specific type of custom resource to the desired state for that specific type of custom resource.

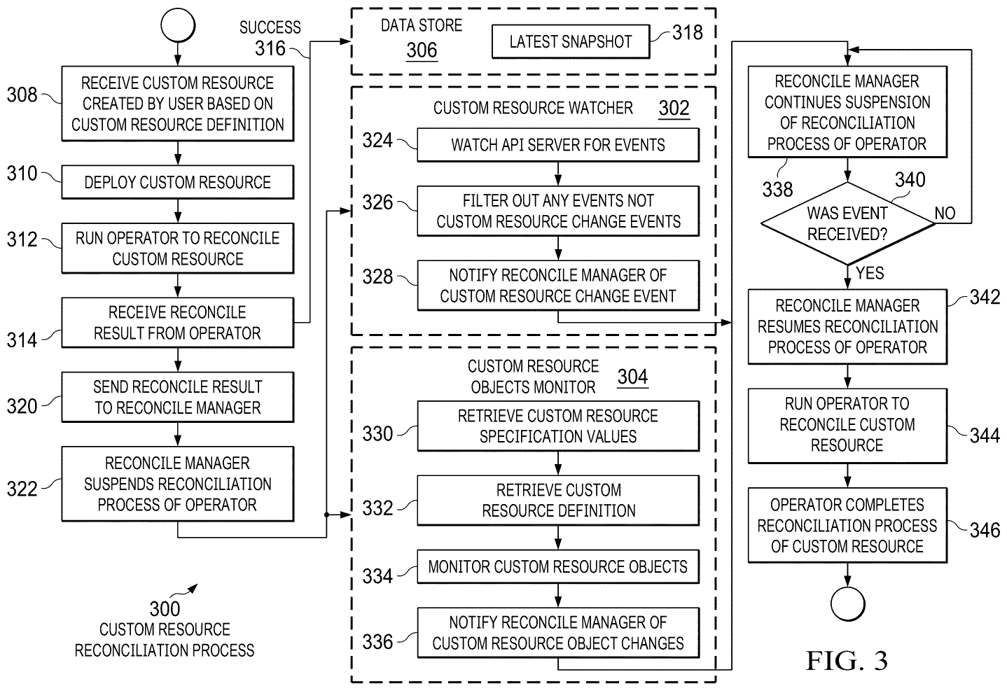

With reference now to FIG. 3, a diagram illustrating an example of a custom resource reconciliation process is depicted in accordance with an illustrative embodiment. Custom resource reconciliation process 300 can be implemented in an orchestration environment, such as, for example, orchestration environment 201 in FIG. 2.

In this example, custom resource reconciliation process 300 includes custom resource watcher 302, custom resource object monitor 304, and data store 306, such as, for example, custom resource watcher 228, custom resource object monitor 230, and data store 212 in FIG. 2. However, it should be noted that custom resource reconciliation process 300 is intended as an example only and not as a limitation on illustrative embodiments. For example, custom resource reconciliation process 300 can include other components (e.g., a reconcile manager such as reconcile manager 226 in FIG. 2), and steps not shown.

At 308, a control node, such as, for example, control node 204 in FIG. 2, receives a custom resource, such as, for example, custom resource 222 of FIG. 2, which was created by a user based on a custom resource definition. At 310, the control node deploys an instance of the custom resource on a host node. At 312, the control node runs an operator, such as, for example, operator 246 in FIG. 2, to reconcile the current state of the custom resource to a desired state for the custom resource.

At 314, the control node receives a reconcile result from the operator. At 316, if the reconcile result is success, then the control node captures latest snapshot 318 of the custom resource and stores latest snapshot 318 in data store 306. In addition, at 320, the control node sends the reconcile result to the reconcile manager. At 322, the reconcile manager suspends the reconciliation process of the operator corresponding to the custom resource.

Furthermore, the control node monitors the custom resource and objects involved in or corresponding to the custom resource for any changes utilizing custom resource watcher 302 and custom resource objects monitor 304, respectively. For example, at 324, custom resource watcher 302 watches an API server, such as, for example, API server 214 in FIG. 2, for any events that have occurred in the cluster, such as, for example, cluster 202 in FIG. 2. At 326, custom resource watcher 302 filters out any events that are not custom resource change events. If custom resource watcher 302 detects a change event corresponding to the custom resource, then, at 328, custom resource watcher 302 notifies the reconcile manager regarding that change event.

At 330, custom resource objects monitor 304 retrieves specification values corresponding to the custom resource. In addition, at 332, custom resource objects monitor 304 retrieves the custom resource definition corresponding to the custom resource. At 334, custom resource objects monitor 304 monitors objects involved in the custom resource based on the specification values and the custom resource definition corresponding to the custom resource. If custom resource objects monitor 304 detects a change in one or more objects involved in the custom resource, then, at 336, custom resource objects monitor 304 notifies the reconcile manager regarding the change in the one or more objects involved in the custom resource.

Meanwhile, at 338, the reconcile manager is continuing suspension of the reconciliation process of the operator corresponding to the custom resource. At 340, the reconcile manager determines whether a change event corresponding to at least one of the custom resource and one or more of the objects involved in the custom resource was received from at least one of custom resource watcher 302 and custom resource objects monitor 304. If a change event was not received, then the reconcile manager continues suspension of the reconciliation process of the operator corresponding to the custom resource. Conversely, if a change event was received, then, at 342, the reconcile manager resumes the reconciliation process of the operator corresponding to the custom resource.

After the reconcile manager resumes the reconciliation process of the operator, at 344, the reconcile manager runs the operator to reconcile the new current state of the custom resource, which was caused by the change event, to the desired state for the custom resource. At 346, the operator completes the reconciliation process of the custom resource and the reconcile manager once again suspends the reconciliation process of the operator until another change event is detected.

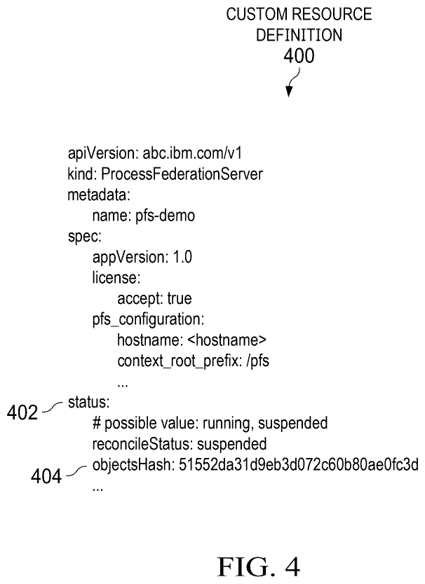

With reference now to FIG. 4, a diagram illustrating an example of a custom resource definition is depicted in accordance with an illustrative embodiment. Custom resource definition 400 corresponds to a custom resource managed by an operator.

In this example, custom resource definition 400 includes reconcile status field 402. The value of reconcile status field 402 can either be running or suspended. In this example, the reconcile status is suspended. In other words, reconciliation of the custom resource by the operator is currently suspended (i.e., cannot be performed). In addition, reconcile status field 402 also contains objects hash 404. Objects hash 404 can be, for example, an MD5 hash or the like. Objects hash 404 is a cryptographic hash of the objects involved in or corresponding to the custom resource managed by the operator.

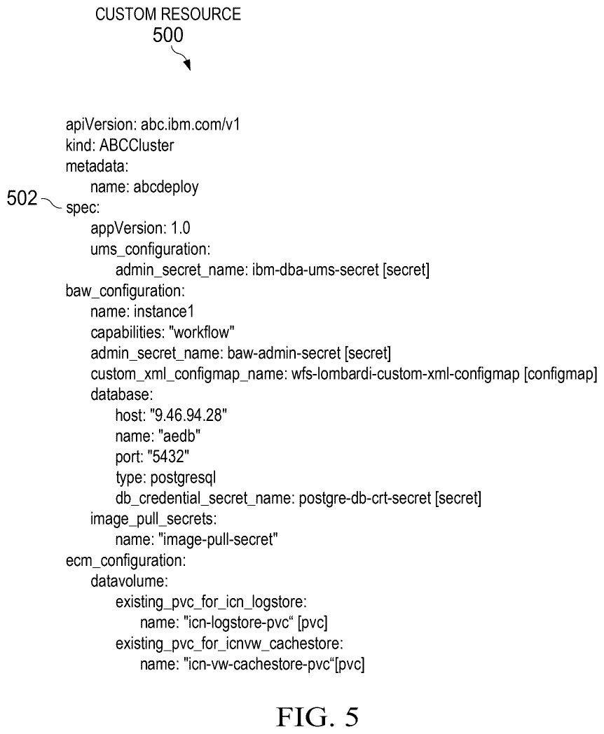

With reference now to FIG. 5, a diagram illustrating an example of a custom resource is depicted in accordance with an illustrative embodiment. Custom resource 500 stores the configuration and status information for the corresponding operator.

Illustrative embodiments utilize a custom resource watcher, such as, for example, custom resource watcher 228 in FIG. 2 or custom resource watcher 302 in FIG. 3, to monitor for changes that can impact the reconcile result of custom resource 500.

Different errors can cause the reconciliation process of custom resource 500 to fail. For example, incorrect inputs in custom resource 500 can cause errors. However, a user can fix these incorrect inputs in custom resource 500 by updating or changing specification section 502 of custom resource 500. For example, if the database host name, image repository name, or the like is input incorrectly, then the user can make the appropriate changes to custom resource 500. As another example, if the configuration is incorrect in the secret, configuration map, or the like, which is needed by custom resource 500, then the user can fix the configuration by changing or updating those objects involved with custom resource 500. For example, the user can change or update the database credential secret in custom resource 500 when the database user, password, and certificate stored in the database credential secret are incorrect. Reconciliation process errors can also be caused by network issues, storage failure, and the like.

The custom resource watcher continuously observes and reacts to changes (e.g., modifications, alterations, updates, or the like) made to custom resource 500, providing a mechanism for the operator to respond to those changes in the configuration of or requested actions by custom resource 500. During initialization, the custom resource watcher establishes a connection with the API server using a client library to identify custom resource 500 managed by the operator. Afterward, the custom resource watcher subscribes to receive notifications whenever custom resource 500 is created, modified, or deleted.

When a change event corresponding to custom resource 500 occurs, the custom resource watcher processes that change event. For example, the custom resource watcher can detect changes in fields, such as specification section 502 or any other operator-specific configuration setting, within custom resource 500. Depending on the type of change event detected, the custom resource watcher can trigger a specific action. For example, if the custom resource watcher detects a change in the reconcile status field to “running,” then the custom resource watcher can signal the reconcile manager to prompt the operator to start the reconciliation process of custom resource 500.

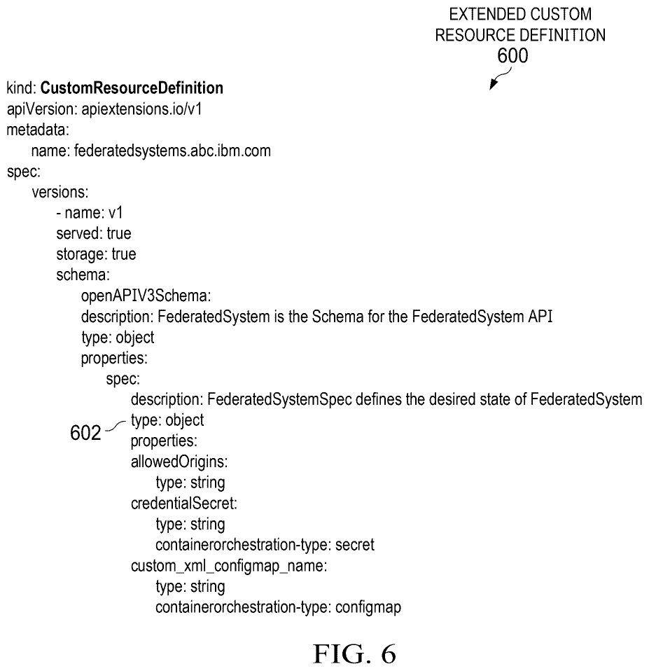

With reference now to FIG. 6, a diagram illustrating an example of an extended custom resource definition is depicted in accordance with an illustrative embodiment. Extended custom resource definition 600 defines the type, such as type 602, of objects involved in or corresponding to the custom resource, such as, for example, custom resource 222 in FIG. 2. Illustrative embodiments utilize a custom resource objects monitor, such as, for example, custom resource objects monitor 230 in FIG. 2 or custom resource objects monitor 304 in FIG. 3, to monitor the objects involved in the custom resource managed by the operator, such as, for example, operator 246 in FIG. 2. The objects are, for example, YAML files, JSON files, or the like that describe the desired state of the custom resource within the cluster, such as configuration maps, secrets, deployments, services, and the like. The custom resource objects monitor ensures that these objects are in synchronization with the actual state of the custom resource in the cluster.

The custom resource objects monitor retrieves the objects involved in the custom resource that is owned and managed by the operator. These objects can be stored in, for example, a version control system, a configuration management tool, or any other storage location. Upon retrieving the objects, the custom resource objects monitor parses the objects to extract information regarding the custom resource the objects define. The custom resource objects monitor identifies the object types (e.g., deployment, service, configuration map, and the like), the object names, and the object configurations.

With the information extracted from the objects, the custom resource objects monitor collects the current state of these objects from the cluster. For example, the custom resource objects monitor communicates with the API server, such as, for example, API server 214 in FIG. 2, to retrieve information regarding the objects in the cluster, such as their current configurations and status. After retrieving the current state of the objects and their configurations, the custom resource objects monitor generates a hash of the objects. The hash serves as a unique fingerprint corresponding to the current state of the objects.

Then, the custom resource objects monitor compares the generated hash with a hash stored in the custom resource definition corresponding to the custom resource managed by the operator. The hash stored in the custom resource definition may be, for example, objects hash 404 in custom resource definition 400 in FIG. 4 If the generated hash and the stored hash do not match, then the custom resource objects monitor determines that the actual state of one or more of the objects has changed. If a difference in the two hashes is detected, then the custom resource objects monitor updates the objects hash field in the custom resource definition with the newly generated hash of the objects. In addition, the custom resource objects monitor also signals the reconcile manager to set the reconcile status field, such as, for example, reconcile status field 402 in FIG. 4, to running in the custom resource definition, signaling that the operator needs to perform the reconciliation process on the custom resource.

The custom resource objects monitor runs periodically, fetching the objects, comparing the objects with the actual cluster state, and updating the custom resource definition as needed. The user can configure the monitoring frequency based on user needs and the rate of change in the objects.

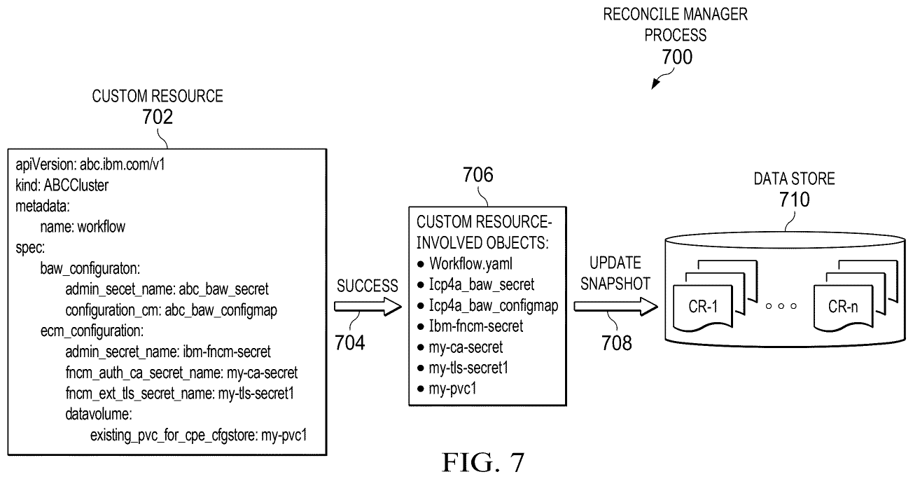

With reference now to FIG. 7, a diagram illustrating an example of a reconcile manager process is depicted in accordance with an illustrative embodiment. Reconcile manager process 700 can be implemented in a reconcile manager, such as, reconcile manager 226 in FIG. 2. The reconcile manager initiates the reconciliation process of the operator corresponding to custom resource 702 when certain conditions are met. In other words, the reconcile manager serves as a control point that determines when and how the custom resource reconciliation process is activated.

For example, the reconcile manager monitors the reconcile status field in the custom resource definition corresponding to the custom resource managed by the operator. The reconcile status field indicates the current state of reconciliation (e.g., running or suspended) of the operator corresponding to custom resource 702. The reconcile manager checks for changes in the reconcile status field based on, for example, external factors, such as changes in custom resource 702 by a cluster administrator, or an internal process, such as the custom resource watcher indicating a change in custom resource 702 or the custom resource objects monitor indicating a change in one or more objects involved in or corresponding to custom resource 702.

Furthermore, the reconcile manager includes a set of predefined conditions, criteria, or rules that determine when to initiate the reconciliation process of the operator. The set of predefined conditions can include, for example, the reconcile status field changing from suspended to running. When the reconcile status field changes to running, the reconcile manager signals the operator to run the reconciliation process on custom resource 702. The set of predefined conditions can also include a predefined time period when the operator runs the reconciliation process at specific time intervals, regardless of the value in the reconcile status field. For example, the operator may perform the reconciliation process on custom resource 702 every minute, 5 minutes, 10 minutes, 30 minutes, hour, or any other increment of time. In addition, the set of predefined conditions can include customized conditions that trigger the reconciliation process based on needs of the operator. For example, a change in a specific field in custom resource 702 can trigger the reconciliation process.

When a condition of the set of predefined conditions is met, the reconcile manager initiates the operator's reconciliation process. Typically, this reconciliation process involves invoking the needed functions and routines to ensure that the actual state of custom resource 702 matches the desired state defined in the objects involved in custom resource 702. At 704, when the operator successfully completes the reconciliation process, the reconcile manager updates the value in the reconcile status field in the custom resource definition to indicate suspended again. As a result, the operator waits for another condition to be met.

Furthermore, the reconcile manager also captures a snapshot of custom resource 702, along with custom resource-involved objects 706, after successful reconciliation of the current state of custom resource 702 with the desired state for custom resource 702. At 708, the reconcile manager updates data store 710 with the current snapshot of custom resource 702 and custom resource-involved objects 706. The current snapshot stored in data store 710 can be, for example, latest snapshot 318 in data store 306 in FIG. 3. If the operator returns a reconcile result of fail, then the reconciliation manager sends a notification to the cluster administrator indicating that a previous snapshot of custom resource 702, which the reconcile manager captured after a previous successful reconciliation, exists in data store 710 and includes in the notification a unique key that identifies the previous snapshot in data store 710.

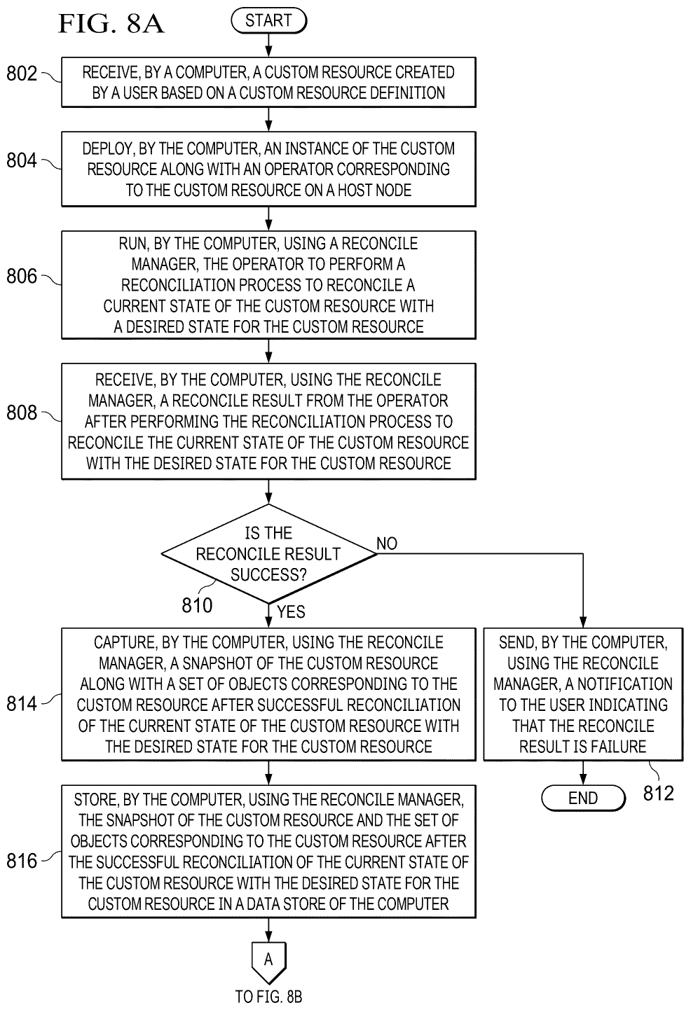

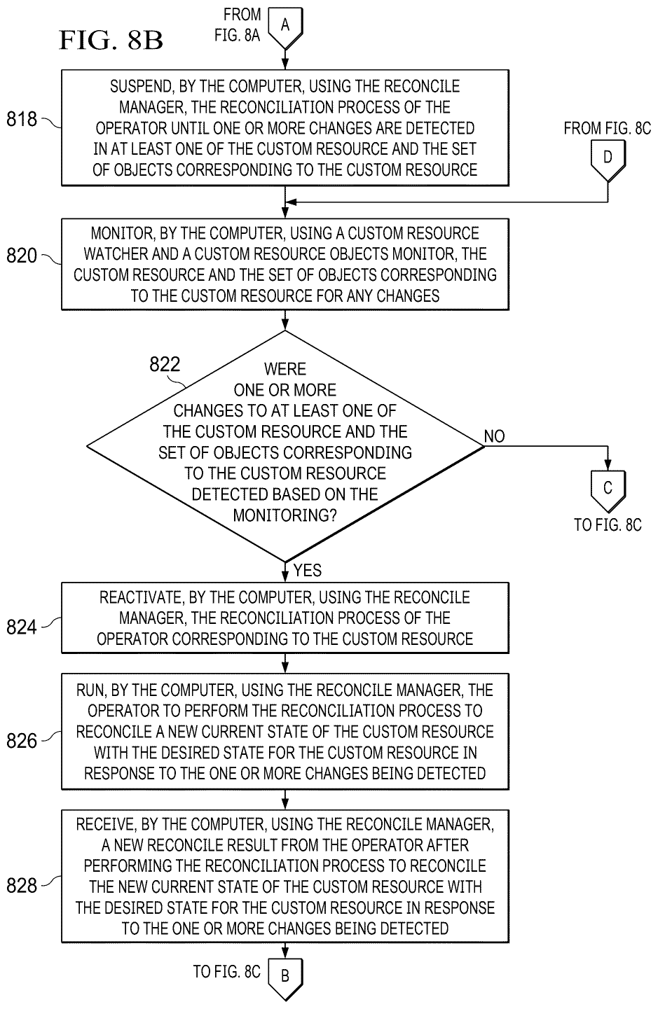

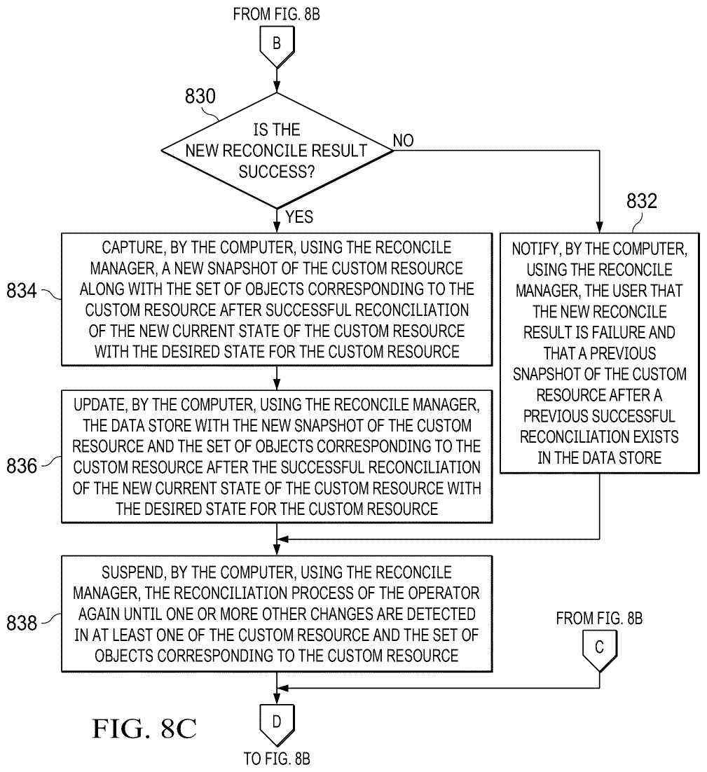

With reference now to FIGS. 8A-8C, a flowchart illustrating a process for managing reconciliation of custom resources by operators is shown in accordance with an illustrative embodiment. The process shown in FIGS. 8A-8C may be implemented in a computer, such as, for example, computer 101 in FIG. 1 or control node 204 in FIG. 2. For example, the process shown in FIGS. 8A-8C may be implemented by operator custom resource reconciliation management code 200 in FIG. 1.

The process begins when the computer receives a custom resource created by a user based on a custom resource definition (step 802). The computer deploys an instance of the custom resource along with an operator corresponding to the custom resource on a host node (step 804). The computer, using a reconcile manager, runs the operator to perform a reconciliation process to reconcile a current state of the custom resource with a desired state for the custom resource (step 806).

The computer, using the reconcile manager, receives a reconcile result from the operator after performing the reconciliation process to reconcile the current state of the custom resource with the desired state for the custom resource (step 808). The computer, using the reconcile manager, makes a determination as to whether the reconcile result is success (step 810).

If the computer, using the reconcile manager, determines that the reconcile result is not success (i.e., fail), no output of step 810, then the computer, using the reconcile manager, sends a notification to the user indicating that the reconcile result is failure (step 812). Thereafter, the process terminates. If the computer, using the reconcile manager, determines that the reconcile result is success, yes output of step 810, then the computer, using the reconcile manager, captures a snapshot of the custom resource along with a set of objects corresponding to the custom resource after successful reconciliation of the current state of the custom resource with the desired state for the custom resource (step 814). The computer, using the reconcile manager, stores the snapshot of the custom resource and the set of objects corresponding to the custom resource after the successful reconciliation of the current state of the custom resource with the desired state for the custom resource in a data store of the computer (step 816).

In addition, the computer, using the reconcile manager, suspends the reconciliation process of the operator until one or more changes are detected in at least one of the custom resource and the set of objects corresponding to the custom resource (step 818). The computer, using a custom resource watcher and a custom resource objects monitor, monitors the custom resource and the set of objects corresponding to the custom resource for any changes (step 820). The computer, using the reconcile manager, makes a determination as to whether one or more changes to at least one of the custom resource and the set of objects corresponding to the custom resource were detected based on the custom resource watcher and the custom resource objects monitor monitoring the custom resource and the set of objects corresponding to the custom resource for any changes (step 822).

If the computer, using the reconcile manager, determines that one or more changes to at least one of the custom resource and the set of objects corresponding to the custom resource were not detected based on the custom resource watcher and the custom resource objects monitor monitoring the custom resource and the set of objects corresponding to the custom resource for any changes, no output of step 822, then the process returns to step 820 where the computer continues to monitor the custom resource and the set of objects corresponding to the custom resource for any changes. If the computer, using the reconcile manager, determines that one or more changes to at least one of the custom resource and the set of objects corresponding to the custom resource were detected based on the custom resource watcher and the custom resource objects monitor monitoring the custom resource and the set of objects corresponding to the custom resource for any changes, yes output of step 822, then the computer, using the reconcile manager, reactivates the reconciliation process of the operator corresponding to the custom resource (step 824).

Afterward, the computer, using the reconcile manager, runs the operator to perform the reconciliation process to reconcile a new current state of the custom resource with the desired state for the custom resource in response to the one or more changes being detected in at least one of the custom resource and the set of objects corresponding to the custom resource (step 826). The computer, using the reconcile manager, receives a new reconcile result from the operator after performing the reconciliation process to reconcile the new current state of the custom resource with the desired state for the custom resource in response to the one or more changes being detected in at least one of the custom resource and the set of objects corresponding to the custom resource (step 828). The computer, using the reconcile manager, makes a determination as to whether the new reconcile result is success (step 830).

If the computer, using the reconcile manager, determines that the new reconcile result is not success, no output of step 830, then the computer, using the reconcile manager, notifies the user that the new reconcile result is failure and that a previous snapshot of the custom resource after a previous successful reconciliation exists in the data store (step 832). Thereafter, the process proceeds to step 838. If the computer, using the reconcile manager, determines that the new reconcile result is success, yes output of step 830, then the computer, using the reconcile manager, captures a new snapshot of the custom resource along with the set of objects corresponding to the custom resource after successful reconciliation of the new current state of the custom resource with the desired state for the custom resource (step 834). The computer, using the reconcile manager, updates the data store with the new snapshot of the custom resource and the set of objects corresponding to the custom resource after the successful reconciliation of the new current state of the custom resource with the desired state for the custom resource (step 836). Further, the computer, using the reconcile manager, suspends the reconciliation process of the operator again until one or more other changes are detected in at least one of the custom resource and the set of objects corresponding to the custom resource (step 838). Thereafter, the process returns to step 820 where the computer continues to monitor the custom resource and the set of objects corresponding to the custom resource for any changes.

Thus, illustrative embodiments of the present disclosure provide a computer-implemented method, computer system, and computer program product for managing reconciliation of custom resources by operators running on host nodes. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing reconciliation of custom resources by operators, the computer-implemented method comprising:
running, by a computer, an operator to perform a reconciliation process to reconcile a new current state of a custom resource with a desired state for the custom resource in response to one or more changes being detected in at least one of the custom resource and a set of objects corresponding to the custom resource;
receiving, by the computer, a new reconcile result from the operator after performing the reconciliation process to reconcile the new current state of the custom resource with the desired state for the custom resource in response to the one or more changes being detected in at least one of the custom resource and the set of objects corresponding to the custom resource;
determining, by the computer, whether the new reconcile result is success;
responsive to the computer determining that the new reconcile result is success, capturing, by the computer, a new snapshot of the custom resource along with the set of objects corresponding to the custom resource after successful reconciliation of the new current state of the custom resource with the desired state for the custom resource; and
suspending, by the computer, the reconciliation process of the operator again until one or more other changes are detected in at least one of the custom resource and the set of objects corresponding to the custom resource.

2. The computer-implemented method of claim 1, further comprising:
responsive to the computer determining that the new reconcile result is not success, notifying, by the computer, a user that the new reconcile result is failure and that a previous snapshot of the custom resource after a previous successful reconciliation exists in a data store; and
suspending, by the computer, the reconciliation process of the operator again until one or more other changes are detected in at least one of the custom resource and the set of objects corresponding to the custom resource.

3. The computer-implemented method of claim 1, further comprising:
receiving, by the computer, the custom resource created by a user based on a custom resource definition; and
deploying, by the computer, an instance of the custom resource along with the operator corresponding to the custom resource on a host node.

4. The computer-implemented method of claim 1, further comprising:
running, by the computer, the operator to perform the reconciliation process to reconcile a current state of the custom resource with the desired state for the custom resource;
receiving, by the computer, a reconcile result from the operator after performing the reconciliation process to reconcile the current state of the custom resource with the desired state for the custom resource; and
determining, by the computer, whether the reconcile result is success.

5. The computer-implemented method of claim 4, further comprising:
responsive to the computer determining that the reconcile result is success, capturing, by the computer, a snapshot of the custom resource along with the set of objects corresponding to the custom resource after successful reconciliation of the current state of the custom resource with the desired state for the custom resource; and
storing, by the computer, the snapshot of the custom resource and the set of objects corresponding to the custom resource after the successful reconciliation of the current state of the custom resource with the desired state for the custom resource in a data store of the computer.

6. The computer-implemented method of claim 4, further comprising:
responsive to the computer determining that the reconcile result is not success, sending, by the computer, a notification to a user indicating that the reconcile result is failure.

7. The computer-implemented method of claim 1, further comprising:
suspending, by the computer, the reconciliation process of the operator until the one or more changes are detected in at least one of the custom resource and the set of objects corresponding to the custom resource; and
monitoring, by the computer, the custom resource and the set of objects corresponding to the custom resource for any changes.

8. The computer-implemented method of claim 1, further comprising:
determining, by the computer, whether the one or more changes to at least one of the custom resource and the set of objects corresponding to the custom resource were detected based on monitoring the custom resource and the set of objects corresponding to the custom resource for any changes; and
responsive to the computer determining that the one or more changes to at least one of the custom resource and the set of objects corresponding to the custom resource were detected based on the monitoring of the custom resource and the set of objects corresponding to the custom resource for any changes, reactivating, by the computer, the reconciliation process of the operator corresponding to the custom resource.

9. The computer-implemented method of claim 1, further comprising:
updating, by the computer, a data store with the new snapshot of the custom resource and the set of objects corresponding to the custom resource after the successful reconciliation of the new current state of the custom resource with the desired state for the custom resource.

10. A computer system for managing reconciliation of custom resources by operators, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
run an operator to perform a reconciliation process to reconcile a new current state of a custom resource with a desired state for the custom resource in response to one or more changes being detected in at least one of the custom resource and a set of objects corresponding to the custom resource;
receive a new reconcile result from the operator after performing the reconciliation process to reconcile the new current state of the custom resource with the desired state for the custom resource in response to the one or more changes being detected in at least one of the custom resource and the set of objects corresponding to the custom resource;
determine whether the new reconcile result is success;
capture a new snapshot of the custom resource along with the set of objects corresponding to the custom resource after successful reconciliation of the new current state of the custom resource with the desired state for the custom resource in response to determining that the new reconcile result is success; and
suspend the reconciliation process of the operator again until one or more other changes are detected in at least one of the custom resource and the set of objects corresponding to the custom resource.

11. The computer system of claim 10, wherein the set of processors further executes the program instructions to:
notify a user that the new reconcile result is failure and that a previous snapshot of the custom resource after a previous successful reconciliation exists in a data store in response to determining that the new reconcile result is not success; and
suspend the reconciliation process of the operator again until one or more other changes are detected in at least one of the custom resource and the set of objects corresponding to the custom resource.

12. The computer system of claim 10, wherein the set of processors further executes the program instructions to:
receive the custom resource created by a user based on a custom resource definition; and
deploy an instance of the custom resource along with the operator corresponding to the custom resource on a host node.

13. The computer system of claim 10, wherein the set of processors further executes the program instructions to:
run the operator to perform the reconciliation process to reconcile a current state of the custom resource with the desired state for the custom resource;
receive a reconcile result from the operator after performing the reconciliation process to reconcile the current state of the custom resource with the desired state for the custom resource; and
determine whether the reconcile result is success.

14. The computer system of claim 13, wherein the set of processors further executes the program instructions to:
capture a snapshot of the custom resource along with the set of objects corresponding to the custom resource after successful reconciliation of the current state of the custom resource with the desired state for the custom resource in response to determining that the reconcile result is success; and
store the snapshot of the custom resource and the set of objects corresponding to the custom resource after the successful reconciliation of the current state of the custom resource with the desired state for the custom resource in a data store of the computer system.

15. A computer program product for managing reconciliation of custom resources by operators, the computer program product comprising a set of computer-readable storage media having program instructions collectively stored therein, the program instructions executable by a computer to cause the computer to:
run an operator to perform a reconciliation process to reconcile a new current state of a custom resource with a desired state for the custom resource in response to one or more changes being detected in at least one of the custom resource and a set of objects corresponding to the custom resource;
receive a new reconcile result from the operator after performing the reconciliation process to reconcile the new current state of the custom resource with the desired state for the custom resource in response to the one or more changes being detected in at least one of the custom resource and the set of objects corresponding to the custom resource;
determine whether the new reconcile result is success;
capture a new snapshot of the custom resource along with the set of objects corresponding to the custom resource after successful reconciliation of the new current state of the custom resource with the desired state for the custom resource in response to determining that the new reconcile result is success; and
suspend the reconciliation process of the operator again until one or more other changes are detected in at least one of the custom resource and the set of objects corresponding to the custom resource.

16. The computer program product of claim 15, wherein the program instructions further cause the computer to:
notify a user that the new reconcile result is failure and that a previous snapshot of the custom resource after a previous successful reconciliation exists in a data store in response to determining that the new reconcile result is not success; and
suspend the reconciliation process of the operator again until one or more other changes are detected in at least one of the custom resource and the set of objects corresponding to the custom resource.

17. The computer program product of claim 15, wherein the program instructions further cause the computer to:
receive the custom resource created by a user based on a custom resource definition; and
deploy an instance of the custom resource along with the operator corresponding to the custom resource on a host node.

18. The computer program product of claim 15, wherein the program instructions further cause the computer to:
run the operator to perform the reconciliation process to reconcile a current state of the custom resource with the desired state for the custom resource;
receive a reconcile result from the operator after performing the reconciliation process to reconcile the current state of the custom resource with the desired state for the custom resource; and
determine whether the reconcile result is success.

19. The computer program product of claim 18, wherein the program instructions further cause the computer to:
capture a snapshot of the custom resource along with the set of objects corresponding to the custom resource after successful reconciliation of the current state of the custom resource with the desired state for the custom resource in response to determining that the reconcile result is success; and
store the snapshot of the custom resource and the set of objects corresponding to the custom resource after the successful reconciliation of the current state of the custom resource with the desired state for the custom resource in a data store of the computer.

20. The computer program product of claim 18, wherein the program instructions further cause the computer to:
send a notification to a user indicating that the reconcile result is failure in response to determining that the reconcile result is not success.
